(19) United States
(12) Patent Application Publication
(10) Pub. No.: US 2002/0083204 A1
(43) Pub. Date: Jun. 27, 2002

(54) Apparatus and method for image partial transmission on a network

(76) Inventors: Se-Yoon Jeong, Taejon (KR); Kyu-Heon Kim, Seoul (KR); Jae-Yeon Lee, Taejon (KR); Byung-Tae Chun, Taejon (KR); Young-Lae Bae, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/963,275

(22) Filed: Sep. 25, 2001

(30) Foreign Application Priority Data
Dec. 27, 2000 (KR) 2000-83236

(51) Int. Cl. G06F 15/16

(52) U.S. Cl. 709/247

(57) ABSTRACT

The present invention relates to an apparatus and a method for partially transmitting high-resolution and high-volume JPEG (Joint Photographic Experts Group) image data as well as a computer-based recording medium for recording the program to embody the method; and, more particularly, to an apparatus and a method for transmitting the images not by sending the entire data but part of them needed for display only in image data transmission, thus reducing the amount of transmission and shortening waiting time. And to secure the QoS (Quality of Service), the method for partially transmitting image data on a network comprises the steps of; when a server registers an image in its DB, converging the image file to a partial-region-accessible file and storing it and generating information needed for generating partial-region image, which is offset & partial region access information; when a client requests partial region image, the server accesses the corresponding image file, which is stored, based on the offset & partial region access information; and transmitting the generated partial region image to the client.

### FIELD OF THE INVENTION

The present invention relates to an apparatus and a method for partially transmitting high-resolution and high-volume JPEG (Joint Photographic Experts Group) image as well as a computer-based recording medium for recording the program to embody the method; and, more particularly, to an apparatus and a method for transmitting the images not by sending the entire data but part of them needed for display only in image data transmission, thus reducing the amount of transmission and shortening waiting time.

### DESCRIPTION OF THE PRIOR ART

A patent related to shortening waiting time in image data transmission is U.S. Pat. No. 125,211, listed on Sep. 26, 2000, in which waiting time is shortened by transmitting the entire image data successively in order of frequency bands.

In connection with a method reducing the amount of data transmission, there is U.S. Pat. No. 4,996,594, listed on Feb. 26, 2000, in which data are transmitted one by one of dynamic regions and the amount of transmission gets reduced by sending out data different from the previous frames.

The image transmission techniques in the conventional network usually concern ones for transmitting common resolution images, which is being mostly used at present. Hereafter, when the use of network application service increases the demand for quality service of high-resolution and high-volume image will rise, too. But the current technology is not proper to the transmission of high-resolution and high-volume image.

The shortcomings of the conventional technology are set forth in detail hereinafter.

The image format most frequently used today is JPEG. This is because JPEG prides the superior ratio of compression index to picture quality.

As one of JPEG compression methods, there is progressive method, used for network transmission, in which image data are divided according to their frequency bands and sent out in order successively to their frequency band, not the whole data sent at a time when JPEG image are transmitted on a network. The progressive method has been highlighted in the early days of the low-speed internet, a technology in which low-frequency band data are transmitted first, followed by intermediate frequency data and then high frequency data, thus showing outline image first by using the first arrived low frequency band data, then showing more detailed image added to the low frequency data image with the data arriving the next in order. In the early days of the Internet, with low speed, people had to wait long time to see all image data arrive and be shown on a web browser. In that Internet environment of the early days, employing the progressive JPEG technique, Netscape web browser got a rave review by showing the outline data first while downloading image data, which gave users the choice of to wait or not to wait according to their interest, thus shortening the waiting time drastically.

At present, however, with information infrastructure and investment in networks around the world, the Internet speed has improved remarkably. Now the progressive technique has become out of date because network speed has become fast enough to maintain QoS (Quality of Service) even when entire JPEG image is transmitted at a time. But, in the future environment of high-quality service, the current way of transmitting whole data will not be proper because the amount of image will be very big. It's also improper to make use of the progressive method as in the early days of the Internet.

Due to the development of network and computer technology, image data transmission has become a frequent job. Users craving for quality service, the demand for high-resolution and high-volume images increases. Lack of demand for the high-resolution and high-volume image at present, the technology on it still leaves much to be desired. Soon, the transmission of high-resolution and high-volume image will be more frequent. Thus, a method for transmitting such images is necessarily required.

### SUMMARY OF THE INVENTION

It is, therefore, an object of the present invention to provide a partial image transmission apparatus and a method for transmitting data only needed for the display on an client not sending out the entire image in image data transmission, thereby maintaining the QoS, as well as a computer-based recording medium for recording a program to embody the method.

In accordance with an embodiment of the present invention, there is provided an apparatus for partially transmitting image data on a network, comprising: first storage means for storing partial-region-accessible image file; second storage means for storing information, which is offset & partial region access information, needed to generate partial region image; first communication processing means for receiving request for partial region image from a client and transmitting the partial region image requested to the client; and image partial access processing means for extracting the corresponding offset & partial access information, accessing the corresponding image file stored in the first storage means and generating the partial region image based on the extracted offset & partial region access information, and transmitting the generated partial region image to the first communication processing means, in accordance with the request of a partial region image file from the first communication processing means.

In accordance with another embodiment of the present invention, there is provided a method for partially transmitting image data on a network, the method comprising the steps of: a) when a server registers an image in its DB, converging the image file to a partial-region-accessible file and storing it and generating information needed for generating partial-region image, which is offset & partial region access information; b) when a client requests partial region image, the server accesses the corresponding image file, which is stored, based on the offset & partial region access information; and c) transmitting the generated partial region image to the client.

In accordance with an embodiment of the present invention, there is provided a computer-based recoding medium for recording a program to embody the method transmitting partial image on a network, the functions of: a) when registering an image in a server, converting and storing the image file to a partial-region-accessible file and storing, and generating information needed to generate partial region image in this procedure; b) when requested for partial region image from a client, having a server access to the corresponding image file, which is stored in, based on the offset & partial access information and generating the partial region image; and c) transmitting the generated partial region image above to the client.

### BRIEF DESCRIPTION OF THE DRAWINGS

The above and other objects and features of the present invention will become apparent from the following description of the preferred embodiments given in conjunction with the accompanying drawings, in which:

FIG. 1 shows a configuration of a network service system joined with an image partial transmission apparatus in an embodiment of the present invention;

FIG. 2 is a detailed flow chart illustrating the process of converting a common JPEG into a partial-accessible JPEG in the image partial transmission method of the present invention;

FIG. 3 is a detailed flow chart depicting the process of DRI modification of FIG. 2 in an embodiment of the present invention;

FIG. 4 is a detailed flow chart showing the MUC decoding and procedures of FIG. 2 in an embodiment of the present invention;

FIG. 5 illustrates a detailed flow chart of the component processing of FIG. 4 in an embodiment of the present invention;

FIG. 6 is a detailed flow chart depicting the substitute-encoding procedure for the original DC value of FIG. 5;

FIG. 7 is a detailed flow chart describing the process for the display region partial request in the image partial transmission method of the present invention;

FIG. 8 is a detailed flow chart illustrating the JPEG file generation procedure in the request region of FIG. 7 in an embodiment of the present invention; and

FIG. 9 shows a configuration diagram of a partial JPEG image corresponding to a requested region in an embodiment of the present invention.

### DETAILED DESCRIPTION OF THE PREFERRED EMBODIMENTS

Other objects and aspects of the invention will become apparent from the following description of the embodiments with reference to the accompanying drawings, which is set forth hereinafter.

The present invention concerns maintaining the QoS of image data by transmitting data only needed for display on a client not sending out the entire image data.

The present invention presents an image transmission technology for future high-quality image service, and JPEG image, currently the most popular format on the Internet, is the object of an embodiment of the invention.

In order to take full advantage of a JPEG image, in this embodiment of the present invention a method of transmitting images in a complete JPEG format when to send out part of image data needed for display only. For this, JPEG data are modified suitable for network transmission so that necessary part of the data can be selectively transmitted when requested.

The demand for high-quality network service of high-resolution and high-volume image is on the rise. So, a new technology is required for the transmission of it, as the conventional skills are not suitable.

The amount of high-resolution and high-volume image data is enormous. To help understanding, the original data size of a 24 bit color image of red, green and blue 10,000-pixel long and 10,000-pixel high is 286 MB, which takes 229.94 seconds to transmit at 10 Mbpps, the general transmission speed of the current LAN (Local Area Network) systems. If this image is compressed into a JPEG format, it can be shrunken into a twentieth of the original size, which is still 14.3 MB taking 11.4 seconds to be transmitted at a speed of 10 Mbpps. As you can see, with the conventional technology, it's hard to provide a service of high-resolution and high-volume image data on the current network systems. So, to develop a method for transmitting such high-resolution and high-volume image data on network systems is the purpose of the present invention.

To address the problems mentioned above, this invention paid attention to below points.

The image data a user can see at once is restricted by the resolution of his display device. For instance, if the resolution of a user's monitor is 1,000×1,000 and the one of a high-volume image data to see is 10,000×10,000, the user comes to see as much part as 1,000×1,000, a hundredth of the whole data, due to restriction of the resolution his monitor can afford to display.

So, the user has to scroll the screen up and down, right and left to see the data. That is, no matter how big an image data is a user should see only as much as the resolution of his monitor from the entire image. In this case, the user has a total of 10.000×10,000 images, but there is little difference with having an image of 1,000×1,000. In short, the part of data not shown at this moment is unnecessary. Therefore, transmission time can be shortened remarkably by not transmitting the unnecessary data, which is not displayed.

Secondly, a case where display region is scrolled and changed will be explained.

When display region is scrolled and changed, in case a local hard drive has the entire data, the corresponding data is loaded from the local hard drive to the memory of the display device, thus renewing display. Here, when the local hard drive has only part of the entire data, the data for renewing display is requested to a server and loaded from the server hard drive to the memory of the display device.

The difference between the two methods is the time for data loading. The latter takes longer time loading data. But the difference will not be a problem to users as long as they can bear the loading time of the latter method. Paying attention to this point, when transmitting high-resolution and high-volume image data on a network the waiting time of a user can be shortened by sending part of the data needed to display only on a monitor. And when the image needs to be scrolled and renewed and it can be transmitted within a time users can bear, serving the method will be feasible. This method is applicable to the present networks. For instance, the size of a JPEG image 1024×768 XGA, which is most used currently is around 110 KB. It takes about 0.1 second to transmit at a speed of 10 Mbps. It's a time users can wait and also sufficient time to do scrolling as 10 pieces of data can be sent for a second. That is, using a method of sending as much data necessary for display on a client in serving high-resolution and high-volume image data on a network, this method is applicable to the current network environments. In order to serve the method, JPEG processing system for partial transmission of JPEG image is in need, which will be described in this invention hereinafter.

First of all, a technology for accessing necessary part of JPEG data is needed to transmit part of JPEG. For this, a method of converting the present JPEG into JPEG with its DRI (Define Restart Interval) of 1 has been developed. JPEG with the DRI of 1 can decode each MCU (Minimum Coded Unit) independently and also it's possible to access data by the unit of MCU and to take out the data. In this procedure of conversion, offset tables for managing location information of each MCU and information for partial access to JPEG are generated.

When a client requests for part of data for display, a server takes out the necessary data only from the converted JPEG by using the offset tables and the information for partial access, adds information and JPEG header for the data and sends them to the client. Here, the necessary information is sent in a complete JPEG form. The reason is to minimize work for the use in the conventional web browser. That is, all need to be added to the present web browsers is just a simple control for sending data necessary for scrolling and display.

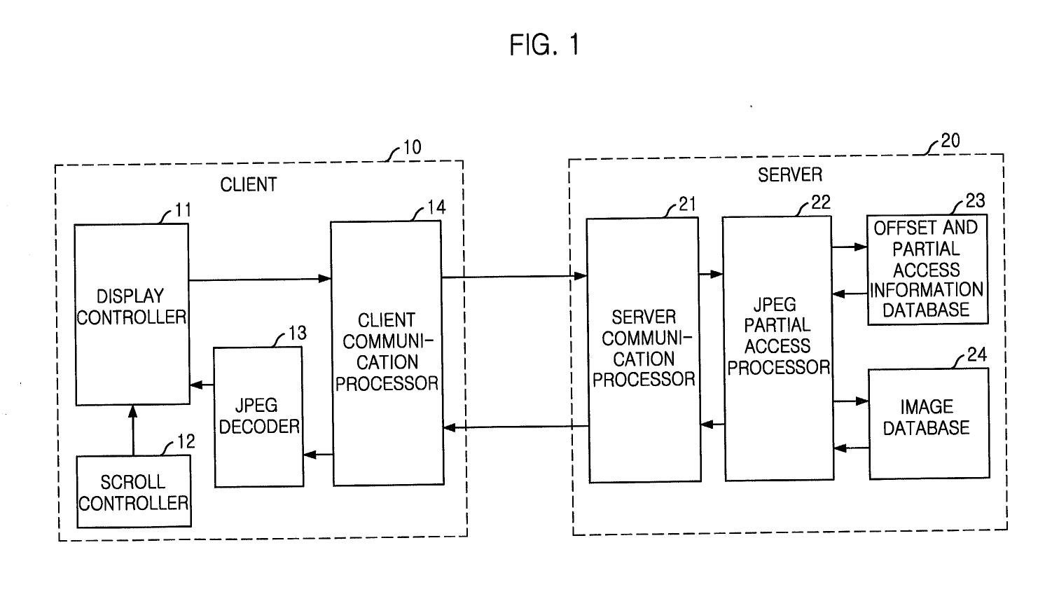

FIG. 1 shows a configuration of an embodiment of a network service system joined with an image partial transmission apparatus in accordance with the present invention.

The network service system consists of a client 10, a device for requesting image partial transmission, and a server 20, a device for image partial transmission. To briefly explain the operation of the service of this system, the client 10 sends a message, marked region partial request message, of requesting for part of data necessary for display to the server 20 and the server 20 receives the message and composes the necessary part of the data into the JPEG format, marked region partial JPEG, and sends it to the client 10.

To take a look at the composition of the server 20, the image partial transmission device, it comprises an image database 24 for storing partial-region-accessible image files; an offset and partial access information database 23 for storing information to generate partial region image file, offset & partial image access information; a server communication processor 21 for being requested for partial region image file, marked region partial request, and transmitting the requested partial region image file, marked region partial JPEG, to the client 10; a JPEG partial access processor 22 for extracting the corresponding offset & partial access information from the offset and partial access information database 23 according to the partial region image request, marked region partial request, from the server communication processor 21, and generating partial region image, marked region partial JPEG, by accessing the corresponding file stored in the image database based on the extracted offset & partial region access information.

Also, the client 10 includes a scroll controller 12 for interpreting the scroll data inputted by a user and ordering and controlling the new region to display; a display controller 11, for requesting partial region image to display the new region, marked region partial request, and controlling the new marked region partial image to display, marked region partial JPEG, under the control of the scroll controller 12; a client communication processor 14, for transmitting partial region image request, marked region partial request, from the display controller 11, receiving the partial region image, marked region partial JPEG, from the server communication processor 21; and a JPEG decoder 13 for decoding the partial region image, marked region partial JPEG, transmitted from the client communication processor 14 and transmitting it to the display controller 11.

First of all, the composition and function of the client 10 will be described.

The client 10 largely includes a display controller 11, a scroll controller 12, a JPEG decoder 13 and a client communication processor 14.

To take a look at how the client of this composition operates, first a user makes use of the scroll controller 12 to browse image. Here, the scroll controller 12 interprets the scroll information inputted by the user and displays a new region of image to the display controller 11.

Then, the display controller 11 has the client communication processor 14 send a message requesting necessary part of image to the server 20 to display the requested region.

Subsequently, in response to this message, the client communication processor 14 receives the JPEG data corresponding to the new display region from the server 20 and transmits it to the JPEG decoder 13.

Then, the JPEG decoder 13 decodes and passes the data to the display controller 11. When the display controller displays the data all the work for the user's scroll order finishes, the client 10 waiting for another order from the user.

Now, the composition and operation of the server 20 will be explained.

The server 20 is largely composed of four parts: a server communication processor 21, a JPEG partial access processor 22, an offset & partial access information database 23 and an image database 24.

To take a look at how the server 20 operates, the server 20 operates according to marked region partial request message from the client 10.

The server communication processor 21 interprets this message and transmits it to the JPEG partial access processor 22.

Then, the JPEG partial access processor 22 requests information needed for generating partial region JPEG to the offset & partial access information database 23 and brings it on. Using this information, the image database 24 accesses the corresponding data and generates partial region JPEG, and after the generation of JPEG corresponding to the part of the marked region request, it has the server communication processor 21 transmit the JPEG data to the client 10.

After that, the server communication processor 21 transmits the JPEG data to the client 10, finishing the work for the request message of the client 10, the server 20 being set in condition of waiting for another request from the client 10.

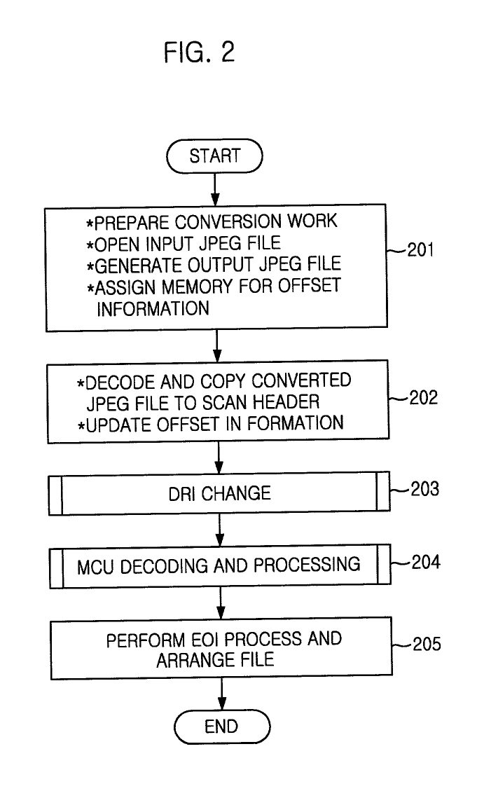

In order to provide the service of FIG. 1, referring to FIG. 2, the procedure of converting JPEG into partial-accessible JPEG will be explained more in detail. This converting procedure is executed when a new image is registered in the image database 24 of the server 20.

Input JPEG files are converted into partial-accessible output files and registered in the image database 24, while the generated offset information and information for partial access are generated during the conversion procedure, the generated information which is registered in the offset & partial access information database 23.

Referring to FIG. 2, to describe the procedure of converting into partial-accessible JPEG, first at step 201, a conversion work file and a memory are prepared. In this procedure, an input JPEG file is opened, a converted JPEG file that supports partial access and an output JPEG file are generated and a memory for offset information is assigned.

Then, the converted JPEG file is decoded to the scan header and then copied and recorded in the output file, the target file. Here, the DC (Direct Current) tables of Huffman table are replaced with standard tables and recorded. And, at step 202, offset location information of the JPEG file to the scan header is stored in offset information. This is because when partial region JPEG is made at later steps, the JPEG files are copied and used to the scan header.

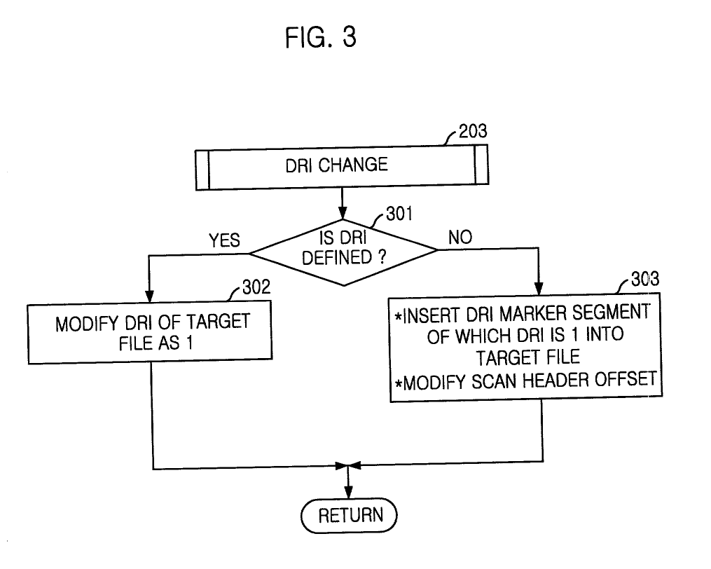

Subsequently, at step 203, the DRI of the target file is changed. For the target file to access partially, all MCU should be independent. For this, DRI should be defined to be 1, meaning all MCUs are independent. This procedure of changing DRI is illustrated in FIG. 3.

Referring to FIG. 3 and taking a look at the procedure of DRI change at step 203, it is determined whether the DRI is defined in input JPEG at step 301 as there can be cases where the DRI is or is not defined in the input JPEG; in case of DRI defined the DRI already copied into the target file is modified at step 302; in case of DRI not defined a DRI marker segment is generated, inserted in front of the scan header of the target file; and the offset location information to the scan header is modified at step 303.

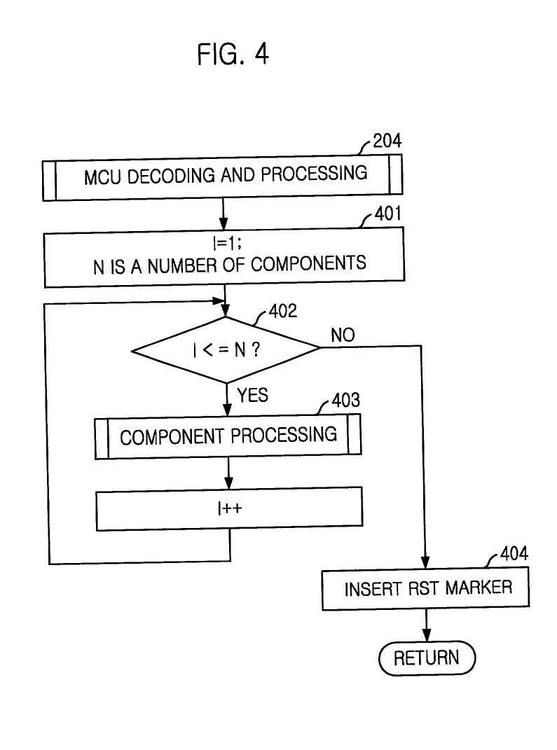

After the procedure of DRI modification, MCU decoding & processing is carried out at step 204. This is done for all MCUs unit by unit. The decoding & processing procedure for a single MCU is shown in FIG. 4.

Referring to FIG. 4 and taking a look at the decoding & processing procedure for a single MCU at step 204, this processing is conducted N-times, N being the number of components included in the scan. These components in baseline JPEG are brightness Y, color difference information from blue Cb and color difference information from red Cr, thus N=3.

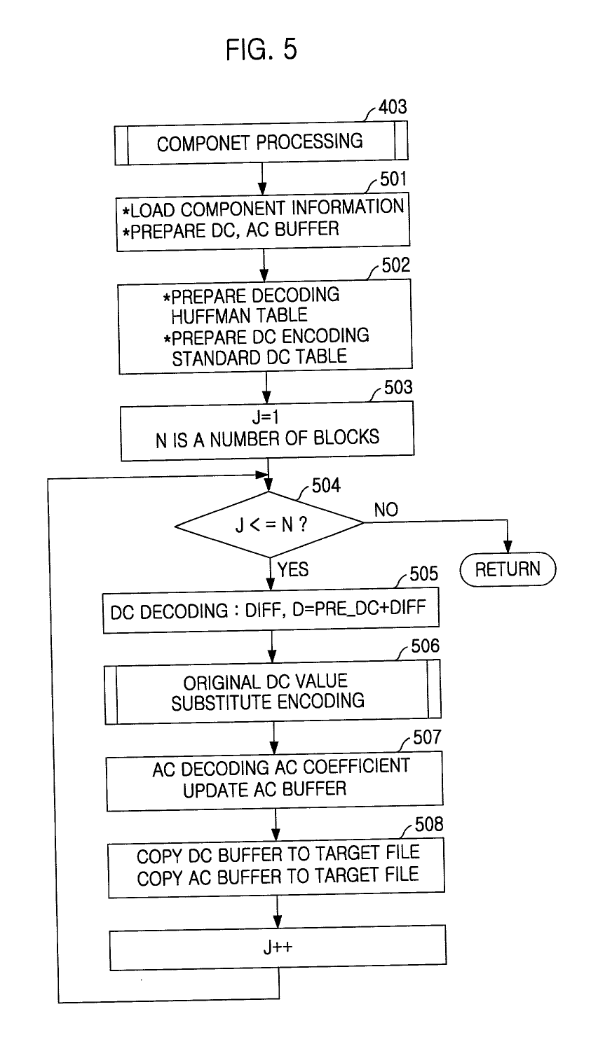

Conducting the component processing (see FIG. 5) N-times at steps 402 and 403 and doing the work of Restart (RST) marker insertion at step 404, the MCU decoding & processing procedure of step 204 finishes. The RST marker insertion is a work of inserting the RST marker to the target file by calculating and inserting the number of RST marker thereto.

Referring to FIG. 5 and taking a look at the procedure of component processing of step 403 of FIG. 4, component information, DC (Direct Current) and AC (Alternative Current:) buffer are prepared at step 501. Here, the component information is the index number of DC and AC Huffman table needed for decoding and the number of block corresponding to the component in MCU. The DC buffer is a memory to store DC data, which is encoded by using the standard Huffman DC table, while the AC buffer is a buffer to store the AC data, which is encoded by the original JPEG Huffman. The AC coefficient is copied and stored in the AC buffer as it is, because it was not changed in the overall modification process.

Then, DC and AC Huffman tables corresponding to the numeral order of a Huffman table and the standard Huffman DC table for encoding the DC are prepared at step 502.

Subsequently, after the preparation of tables, steps 503 to 508 are conducted for the N number of blocks.

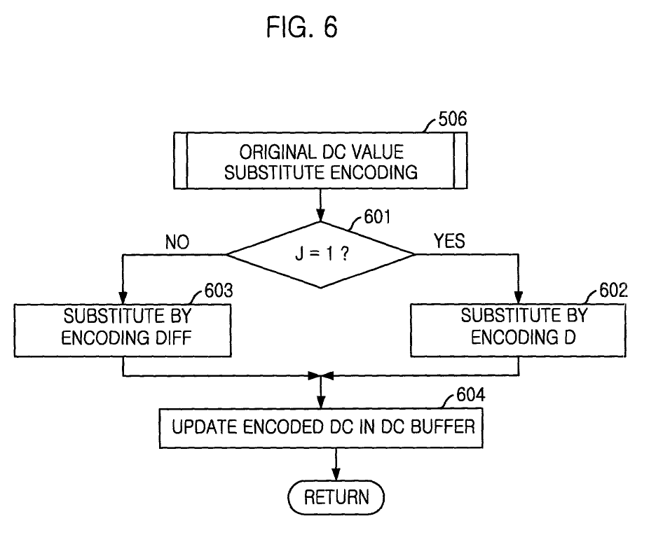

In this work for the blocks, difference information DIFF is obtained first by decoding the DC. This decoded DIFF is the difference from the previous DC. Adding the previous DC to this DC, the value of the original DC can be obtained at step 505, which is illustrated in FIG. 6.

Referring to FIG. 6 and taking a look at the procedure of the original DC value substitute encoding, the step 506, when J=1, the original DC coefficient D is encoded by using the standard DC table at steps 601 and 602. For the other cases, the decoded DC Coefficient DIFF is encoded by using the standard table at steps 601 and 603.

Then, the encoded DC is updated in the DC buffer at step 604.

In the meantime, after finishing the procedure of the original DC substitute encoding, AC coefficient gets decoded at step 507. Here, the AC coefficient is decoded in order to know where the AC data of this block begins and finishes in the original JPEG file. And, at step 507, the data part of the AC coefficient obtained by decoding it is copied to the AC buffer as they are.

Subsequently, the DC buffer is copied to the target file prior to the AC buffer, which should also be copied to it, and a process for one block is finalized at step 508.

Performing this procedure N-times, the component processing finishes.

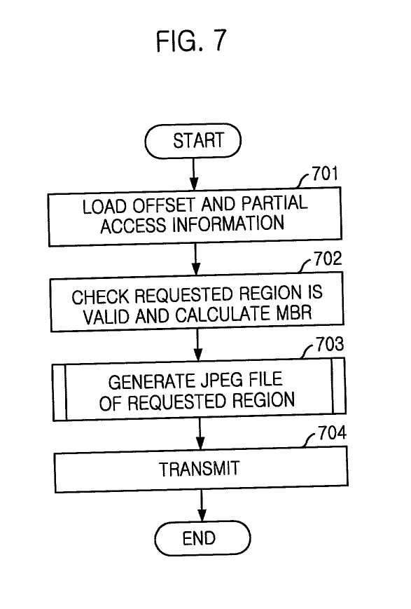

FIG. 7 shows the process of generating JPEG files corresponding to the region requested by the JPEG partial access processor 22 when the marked region partial request message is transmitted to the server 20.

At step 701, when the marked region partial request message is transmitted from the client 10 to the server 20, the JPEG partial access processor 22 first loads the necessary information from the offset & partial access information database 23. This information concerns the location of the file to its scan header, information of MCU composition and information of each MCU offset.

Then, at step 702, it is checked if the region requested is a valid region, that is, it is checked if the region is accessible from the original image, and if it is a valid region the MBR (Minimum Boundary Rectangle) including the region is calculated. Here, the reason calculating MBR is that JPEG can access by the unit of MCU. That is, a square region in the unit of MCU, which includes the requested region is obtained. For instance, when H and V of all components of MCU are 1, that is, in case each component includes a single block, one MCU corresponds to information 8-pixel long and 8-pixel high. Here, when the requested region is (50, 50) to (250, 250), the region of (48, 48) to (255, 255) is brought, as the access should be done by the unit of MCU. That is, the accessible minimum unit is the MCU size. Therefore, the MCU unit including the requested region is calculated.

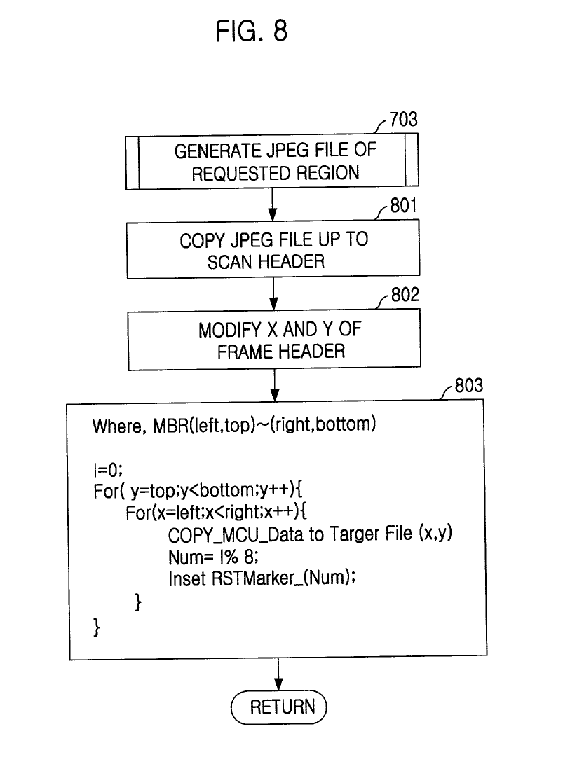

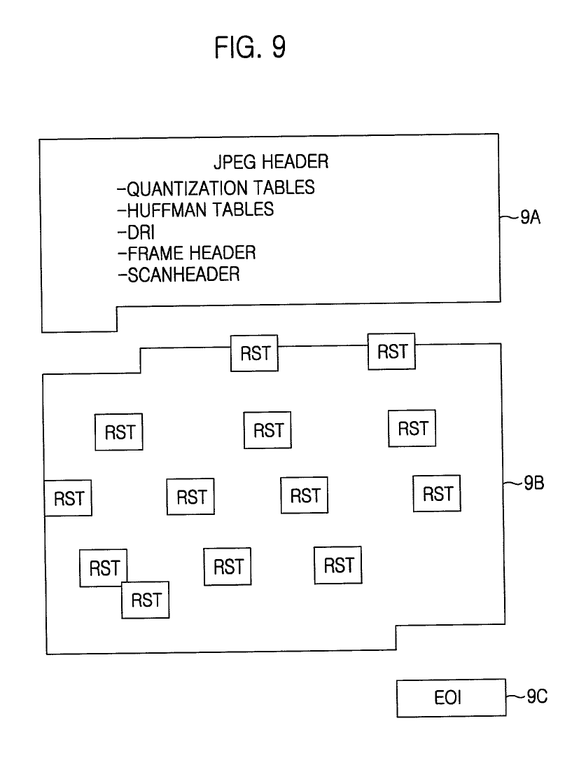

After that, at step 703, requested region JPEG file is generated. The procedure of generating the requested JPEG file of step 703 is illustrated in FIG. 8, and the structure of the requested region JPEG file, which is generated, is shown in FIG. 9.

Referring to FIG. 8 and taking a look at the procedure of generating requested region JPEG file of step 703, the JPEG file is copied up to the scan header at step 801.

Then, at step 802, the X and Y of a frame header are modified into the width and height of the MBR calculated and obtained at the step 702. What has been generated here so far is shown in FIG. 9A.

Subsequently, at step 803, MCUs corresponding to MBR are brought and recorded in the generated file, and an RST marker is inserted. What is generated by this step is seen in FIG. 9B.

Finally, EOI (end of image) marker is recorded. What is generated by this step is in FIG. 9C.

At step 704, the JPEG file generated through the above steps is transmitted to the client 10, and the generation of requested region partial JPEG terminates.

The method of the present invention mentioned above can be embodied in a form of a program and recorded in recording media such as CD roms, RAMs, ROMs, floppy disks, hard disks, optical-magnetic disks and the like.

As shown above, the present invention has following effects.

First, when browsing high-resolution and high-volume image on a network, the present invention shortens the user waiting time and enables to serve high-resolution and high-volume image data in the current network environment by transmitting part of the data necessary for display alone.

Secondly, the present invention is available in the present browsers by transmitting the necessary part of the whole image data in a complete JPEG format, when sending the part of the data.

Thirdly, the present invention relieves a client from the burden of lacking space for storage and of operation. To process high-volume image data, a storage device with high-capacity and a high-performance operation device are required. Moreover, it takes considerable time to load image to a graphic memory of a client. In this method of the present invention, in which a necessary part of an image data is sent to a client, with small amount of data to be processed, the time for loading data to the graphic memory can be shortened and the memory space of a storage device is saved as well.

While the present invention has been described with respect to certain preferred embodiments, it will be apparent to those skilled in the art that various changes and modifications may be made without departing from the scope of the invention as defined in the following claims.

What is claimed is:

1. An apparatus for partially transmitting image data on a network, comprising:
a first storage means for storing partial-region-accessible image file;
a second storage means for storing information, which is offset & partial region access information, needed to generate partial region image;
a first communication processing means for receiving request for partial region image from a client and transmitting the partial region image requested to the client; and
an image partial access processing means for extracting the corresponding offset & partial access information, accessing the corresponding image file stored in the first storage means and generating the partial region image based on the extracted offset & partial region access information, and transmitting the generated partial region image to the first communication processing means, in accordance with the request of a partial region image file from the first communication processing means.

2. The apparatus of claim 1, wherein the client includes:
a scroll control means for interpreting scroll information inputted by a user, and ordering and controlling a new region to display;
a display control means for requesting partial region image to display the new region and controlling the partial image of the new region to display, under the control of the scroll control means;
a second communication processing means for transmitting the request for partial region image file from the display control means to the first communication processing means and receiving the partial region image from the first communication processing means; and
a decoding means for decoding the partial region image transmitted from the second communication processing means and sending it to the display control means.

3. The apparatus of claims 2, wherein the partial region image is substantially a partial image of a high-resolution and high-volume JPEG (Joint Photographics Expert Group) image data.

4. The apparatus of claims 1, wherein the partial region image is substantially a partial image of a high-resolution and high-volume JPEG (Joint Photographics Expert Group) image data.

5. The apparatus of claim 4, wherein the DRI (Define Restart Interval) of present JPEGs are modified to be 1 so that each MCU can be decoded independently and data can be brought in order to access and transmit the necessary part of a JPEG, and the offset table and information for JPEG partial access are generated during the DRI modification procedure, when an image data is converted to a partial region accessible image file.

6. A method for partially transmitting image data on a network, the method comprising the steps of:
a) when a server registers an image in its DB, converging the image file to a partial-region-accessible file and storing it and generating information needed for generating partial-region image, which is offset & partial region access information;
b) when a client requests partial region image, the server accesses the corresponding image file, which is stored, based on the offset & partial region access information; and
c) transmitting the generated partial region image to the client.

7. The method as recited in claim 6, wherein the partial region image is substantially a high-resolution and high-volume JPEG (Joint Photographics Expert Group) image data.

8. The method as recited in claim 7, wherein the DRI (Define Restart Interval) of present JPEGs is modified to be 1 so that each MCU can be decoded independently and data can be brought in order to access and transmit the necessary part of a JPEG, and the offset table and information for JPEG partial access are generated during the DRI modification procedure, when an image data is converted to a partial region accessible image file.

9. The method as recited in claim 6, wherein the step a) includes the steps of:
d) preparing a conversion file and memory, opening an input JPEG file, generating a converted JPEG that supports partial access and output JPEG files, and assigning memory for offset information;
e) decoding the input JPEG file to the scan header, copying and recording it in the output file, the target file, and storing its offset location information to the scan header in the offset information;
f) modifying and processing the DRI (Define Restart Interval) of the target file; and
g) decoding and processing the MCU (Multipoint Control Unit.

10. The method as recited in claim 7, wherein the step a) includes the steps of:
d) preparing a conversion file and memory, opening an input JPEG file, generating a converted JPEG that supports partial access and output JPEG files, and assigning memory for offset information;
e) decoding the input JPEG file to the scan header, copying and recording it in the output file, the target file, and storing its offset location information to the scan header in the offset information;
f) modifying and processing the DRI (Define Restart Interval) of the target file; and
g) decoding and processing the MCU (Multipoint Control Unit.

11. The method as recited in claim 9, wherein, in the step f), it is determined whether the input JPEG is defined as the DRI could or could not be defined in the input JPEG, and if the DRI is defined the DRI already copied in the target file is modified to be 1, and if it is not defined a DRI marker segment is generated and inserted in front of the scan header of the target file and the offset location information to the scan header is modified.

12. The method as recited in claim 11, wherein, in the step g), component processing is conducted N-times, N being the number of components in the scan and RST marker insertion, in which the RST marker is inserted into the target file by calculating the numeral order of the RST marker, is carried out.

13. The method as recited in claim 12, wherein the procedure of the component processing includes the steps of:
h) preparing component information and DC and AC buffers;
i) preparing DC and AC Huffman tables corresponding to the numeral order of Huffman table and the standard Huffman table for encoding the DC; and
J) for N number of blocks, decoding the DC and calculating the DIFF, calculating D of the original DC value by adding the DC to the previous DC, by encoding the obtained DC value by using the standard table and updating it to DC buffer, decoding the AC coefficient and copying the data part of the AC coefficient obtained by the decoding procedure, copying the DC buffer to the target file first and then copying the AC buffer.

14. The method as recited in claim 13, wherein, in the procedure of substitute-encoding the original DC value of the step j), if J=1 the D of the original DC coefficient is encoded by using the standard table, otherwise, the decoded DC and DIFF are encoded by using the standard table and the newly encoded DC is updated to the DC buffer.

15. The method as recited in claim 6, wherein the step b) includes the steps of:
d) if the message of display region partial request is sent from the client to the server, the information for the offset & partial access information database being loaded to a JPEG partial access processor of the server;
e) checking if the requested region is a valid region, accessible from the original image, if it is, calculating the MBR (Minimum Boundary Rectangle) including the region; and
f) generating the requested region JPEG file, copying it up to the scan header, modifying X and Y of its frame header to the width and height of the MBR obtained in the step e), bringing MCUs (Multipoint Control Unit) corresponding to the MBR one by one and recoding them in the generated file and inserting the RST marker thereto, and recoding an EOI (End of Image) marker.

16. The method as recited in claim 7, wherein the step b) includes the steps of:
d) if the message of display region partial request is sent from the client to the server, the information for the offset & partial access information database being loaded to a JPEG partial access processor of the server;
e) checking if the requested region is a valid region, accessible from the original image, if it is, calculating the MBR (Minimum Boundary Rectangle) including the region; and
f) generating the requested region JPEG file, copying it up to the scan header, modifying X and Y of its frame header to the width and height of the MBR obtained in the step e), bringing MCUs (Multipoint Control Unit) corresponding to the MBR one by one and recoding them in the generated file and inserting the RST marker thereto, and recoding an EOI (End of Image) marker.

17. The method as recited in claim 6, wherein the server modify the DRI (Define Restart Interval) of present JPEGs to be 1 so that each MCU can be decoded independently and data can be brought in order to access and transmit the necessary part of a JPEG, generating the offset table and information for JPEG partial access during the DRI modification procedure, and when part of data needed for display is requested from the client, the server brings the necessary data from the converted JPEG by using information needed for the offset table and partial access, adds JPEG headers and information fit for the data and sends them to the client in a complete JPEG format.

18. The method as recited in claim 7, wherein the server modify the DRI (Define Restart Interval) of present JPEGs to be 1 so that each MCU can be decoded independently and data can be brought in order to access and transmit the necessary part of a JPEG, generating the offset table and information for JPEG partial access during the DRI modification procedure, and when part of data needed for display is requested from the client, the server brings the necessary data from the converted JPEG by using information needed for the offset table and partial access, adds JPEG headers and information fit for the data and sends them to the client in a complete JPEG format.

19. A computer-based recoding medium for recording a program to embody the method transmitting partial image on a network, the functions of:
a) when registering an image in a server, converting and storing the image file to a partial-region-accessible file and storing, and generating information needed to generate partial region image in this procedure;
b) when requested for partial region image from a client, having a server access to the corresponding image file, which is stored in, based on the offset & partial access information and generating the partial region image; and
c) transmitting the generated partial region image above to the client.
